(19) United States
(12) Patent Application Publication
(10) Pub. No.: US 2009/0019973 A1
(43) Pub. Date: Jan. 22, 2009

(54) Socket assembly for quickly releasing object engaged with the socket

(76) Inventor: Yeu-Perng NIEH, Ta-Li City (TW)

Correspondence Address: PHILLIP LIU, 6980, WHITEOAK DR., RICHMOND, BC, V7EAZ9, CA

(21) Appl. No.: 11/900,990

(22) Filed: Sep. 14, 2007

(30) Foreign Application Priority Data
Jul. 20, 2007 (TW) 096211947

(51) Int. Cl. B25B 23/02; B25B 13/06

(52) U.S. Cl. 81/124.1

(57) ABSTRACT

A socket assembly includes a socket having a mounting hole which includes a plurality of insides and yield recesses located alternatively between the insides. A control member is rotatably mounted to the socket and has a through hole, a plurality of stops extend inward from an inner periphery of the through hole. A polygonal object is engaged with the mounting hole of the socket and the stops of the control member are located on the path along which the polygonal object may drop from the socket. After the object is loosened and received in the socket, the control member is rotated an angle to remove the stops such that the path that the polygonal object may drop is clear and the object is easily take out from the socket.

### FIELD OF THE INVENTION

The present invention relates to a socket assembly including a control member which is rotatably mounted to the socket and allows the object engaged with the socket to quickly release from the socket.

### BACKGROUND OF THE INVENTION

A conventional socket generally includes a polygonal hole for accommodating the object such as a bolt head or a nut, the socket is driven by a hand tool so as to loosen the object from another object. However, when the bolt is threadedly connect to a board for example, and located in a deep position, when using the socket to loosen the bolt, the loosened bolt drops from the socket due to gravity and the user cannot retrieve the bolt conveniently. Some sockets are equipped with a spring ring which is engaged with the socket such that the loosened bolt can be retained in the socket. The bolt and the socket are then removed from the deep position and the bolt can be pulled out from the socket. Nevertheless, if the object is a nut which is completely received in the socket, the user cannot conveniently pick the nut out from the socket.

The present invention intends to provide a socket assembly which is cooperated with a control member which controls the path that the object is allowed to drop from the socket.

### SUMMARY OF THE INVENTION

The present invention relates to a socket assembly that comprises a socket and a control member, wherein the socket includes an engaging hole in a first end thereof and a mounting hole in a second end of the socket. The mounting hole includes a plurality of insides and yield recesses located alternatively between the insides. A rail is defined in an outer periphery of the socket and shares an axis of the socket. A control member is rotatably mounted to the socket and has a through hole defined centrally therethrough. A plurality of stops extend inward from an inner periphery of the through hole. A ridge extends inward from an inner periphery thereof and the ridge is movably engaged with the rail. A polygonal object has sides and corners connected between the sides. A distance “B1” from an axis of the object to each one of the sides is not larger than a distance “A1” from an axis of the control member to each one of the stops of the control member. The distance “A1” is not larger than a distance “B2” from the axis of the object to each of the corners of the object and a distance “C2” from the axis of the socket to each of the yield recesses of the socket. A distance “B2” is not larger than a distance “A2” from the axis of the control member to the inner periphery of the through hole.

The primary object of the present invention is to provide a socket assembly which has a control member rotatably mounted thereto and the control member includes stops which are located at the path along which the object in the socket may drop. The stops are removed away from the path by rotating the control member so that the object in the socket can easily drop from the socket.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show the socket assembly of the present invention;

FIG. 2 is a top view to show the distances C1 and C2 of the socket;

FIG. 3 is a top view to show the distances A1 and A2 of the control member;

FIG. 4 is a top view to show the distances B1 and B2 of the polygonal object;

FIG. 5 is a cross sectional view to show that the object is engaged with the mounting hole of the socket;

FIG. 6 is a cross sectional view to show that the control member is rotated and the stops 221 removed to allow the object to drop from the socket;

FIG. 7 is a cross sectional view, taken along line D-D in FIG. 5;

FIG. 8 is a cross sectional view, taken along line E-E in FIG. 5;

FIG. 9 is a cross sectional view, taken along line F-F in FIG. 6;

FIG. 10 is a cross sectional view, taken along line G-G in FIG. 6;

FIG. 11 shows a second embodiment of the mounting hole of the socket;

FIG. 12 shows a third embodiment of the mounting hole of the socket;

FIG. 13 shows a fourth embodiment of the mounting hole of the socket;

FIG. 14 shows a fifth embodiment of the mounting hole of the socket, and FIG. 15 is an exploded view to show another embodiment of the socket assembly of the present invention.

### DETAILED DESCRIPTION OF THE PREFERRED EMBODIMENT

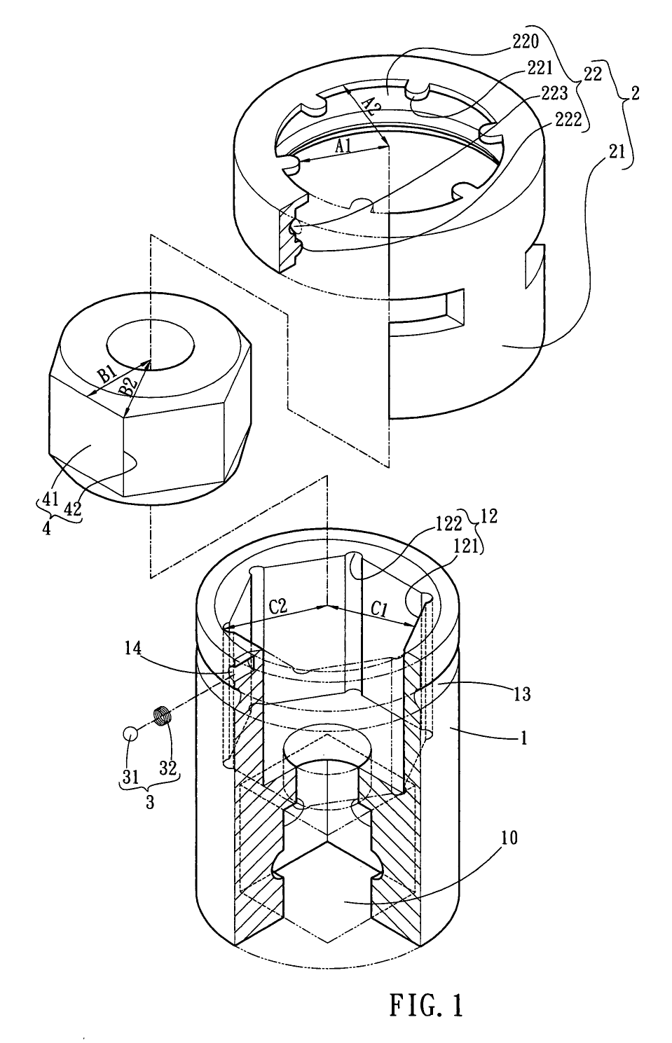

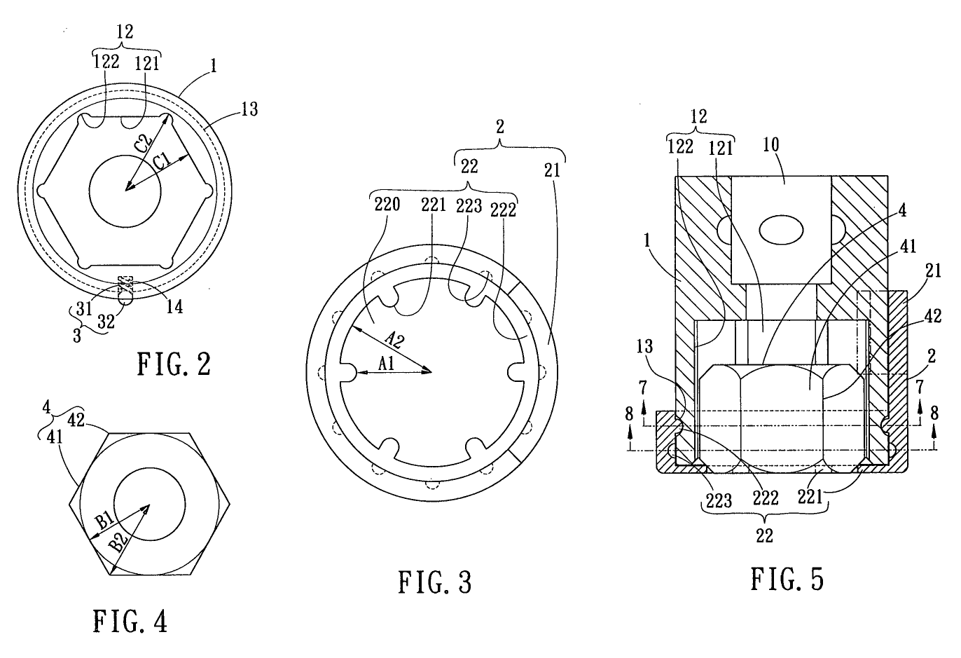

Referring to FIGS. 1 to 5, the socket assembly of the present invention comprises a socket 1 and a control member 2. The socket 1 includes an engaging hole 10 defined in a first end thereof so as to be connected with a hand tool which is not shown, and a mounting hole 12 defined in a second end of the socket 1 so as to be mounted to a polygonal object 4. The mounting hole 12 is a polygonal hole and includes a plurality of insides 121 and yield recesses 122 which are located alternatively between the insides 121. The engaging hole 10 is in communication with the mounting hole 12. The socket 1 includes a positioning device which is a reception hole 14 defined radially through a wall of the socket 1 and a positioning unit 3 is engaged with the reception hole 14. The positioning unit 3 includes a bead 31 and a spring 32 which biases the bead 31 to partially protrude from the outer periphery of the socket 1.

The control member 2 is rotatably mounted to the socket 1 and includes an operation section 21 and a function section 22. The function section 22 is a ring-shaped portion and the operation section 21 is connected axially to the function section 22. The function section 22 includes a through hole 220 defined centrally therethrough and a plurality of stops 221 extend inward from an inner periphery of the through hole 220. The stops 221 are made by resilient material so that the stops 221 can be deformed inward when mounting the socket 1 to the object 4. The control member 2 further includes a plurality of notches 223 defined in an inner periphery of the through hole 220 so that the bead 31 of the positioning unit 3 in the socket 1 is removably engaged with one of the notches 223 so as to position the control member 2 to the socket 1. A ridge 222 extends inward from an inner periphery thereof so as to be movably engaged with a rail 13 defined in an outer periphery of the socket 1, in this embodiment, the rail 13 is a groove. The rail 13 shares an axis of the socket 1.

The polygonal object 4 such as a nut includes six sides 41 and six corners 42 are connected between the sides 41. A distance “B1” from an axis of the object 4 to each one of the sides 41 is not larger than a distance “A1” from an axis of the control member 2 to each one of the stops 221 of the control member 2. The distance “A1” is not larger than a distance “B2” from the axis of the object 4 to each of the corners 42 of the object 4 and a distance “C2” from the axis of the socket 1 to each of the yield recesses 122 of the socket 1. A distance “B2” is not larger than a distance “A2” from the axis of the control member 2 to the inner periphery of the through hole 220.

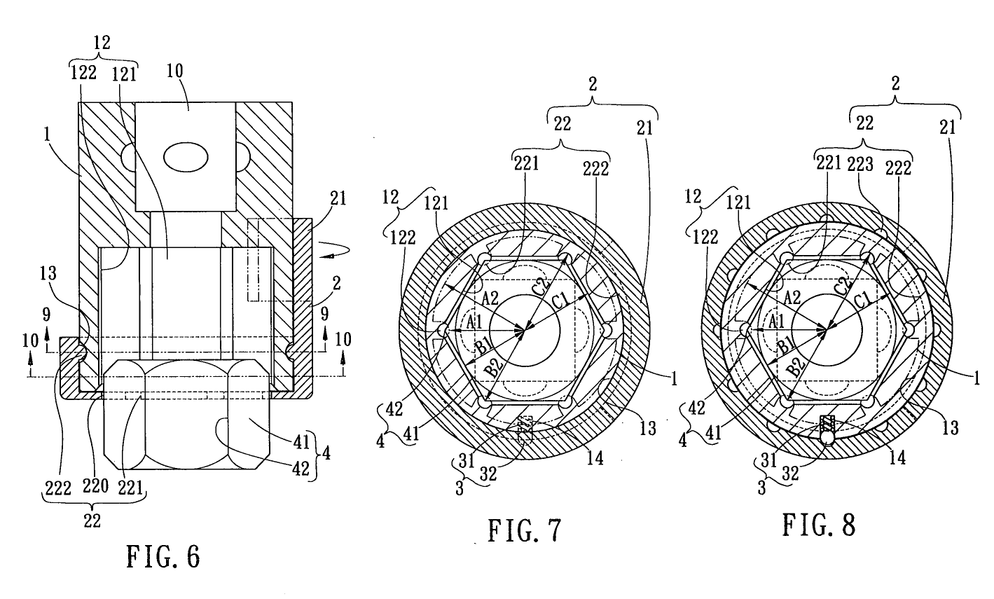

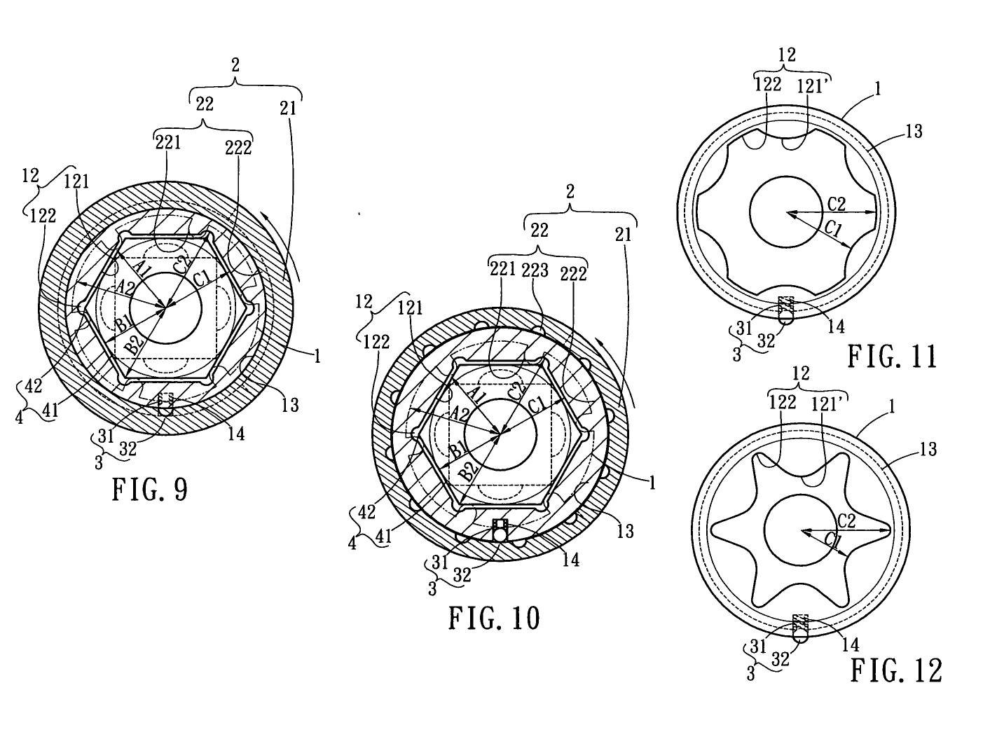

Further referring to FIGS. 5, 7 and 8, when mounting the socket 1 to the object 4, the stops 221 are pushed to be deformed so that the object 4 is engaged with the mounting hole 12 of the socket 1. At least some of the corners 42 are supported or stopped by the stops 221 of the control member 2 so that when the object 4 is completely loosened, the stops 221 are located on the path along which the corners 42 of the object 4 drops from the socket 1. Referring to FIGS. 6, 9 and 10, after the socket 1 is rotated and the object 4 is completely loosened, the user shifts the operation section 21 to rotate the function section 22 about the axis of the socket 1, the stops 221 of the through hole 220 of the control member 2 is removed from the path along which the corners 42 of the object 4 drop from the socket 1. Therefore, the socket 4 can easily drop from the socket due to gravity.

The positioning unit 3 can be a one-piece unit such as a single spring or a single rod with a rounded end.

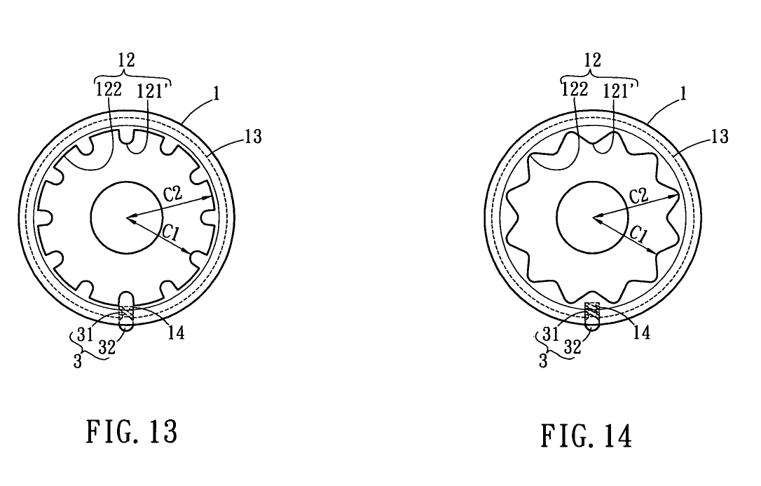

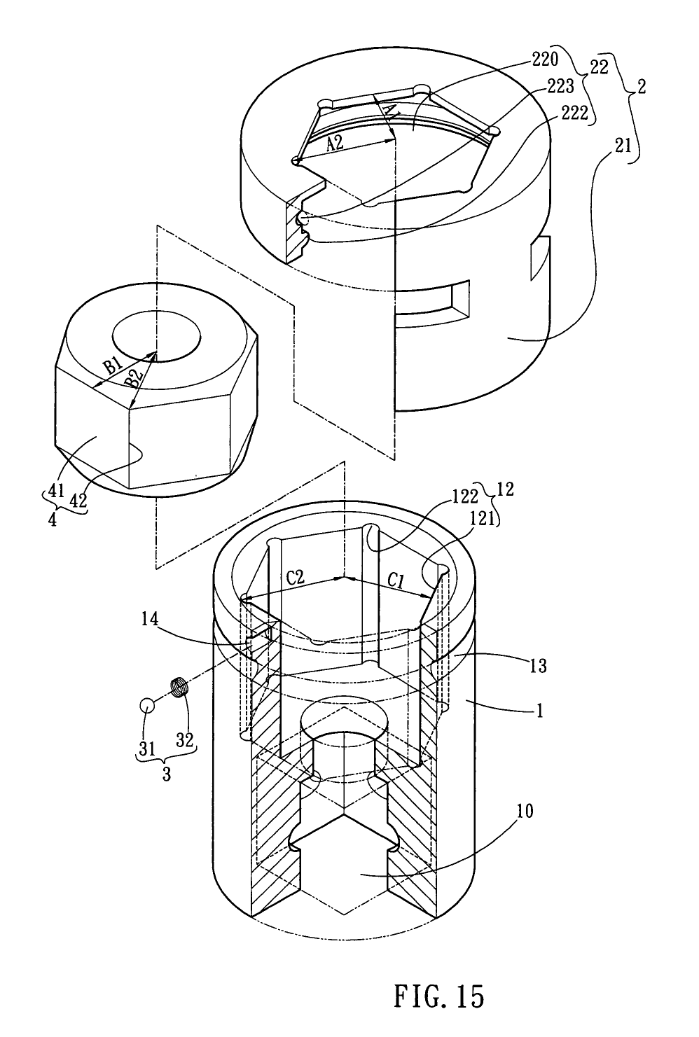

It is noted that the shape of the mounting hole 12 of the socket 1 can be any known shape such as the shapes shown in FIGS. 11, 12, 13 and 14. Each of the shapes includes curved protrusions 121′ and yield notches 122.

FIG. 15 shows another embodiment of the control member 2 of the socket assembly of the present invention, wherein the shape of the through hole 220 of the control member 2 is the same as the shape of the mounting hole 12 of the socket 1. The distance “A1” is a distance from the axis of the second member 2 to each of the insides of the through hole 220, and the distance “A2” is a distance from the axis of the second member 2 to each of the yield recesses of the through hole 220. The insides of the through hole 220 are located on the path that the corners 42 of the object 4 drop from the socket 1 when loosening the object 4. When rotating the control member 2, the insides of the through hole 220 are removed from the path that the corners 42 of the object 4 drop from the socket 1, such that the corners 42 of the object 4 are allowed to pass through the yield recesses of the through hole 220 and drop from the socket 1.

While we have shown and described the embodiment in accordance with the present invention, it should be clear to those skilled in the art that further embodiments may be made without departing from the scope of the present invention.

1. A socket assembly comprising:
a socket having an engaging hole defined in a first end thereof and a mounting hole defined in a second end of the socket, the mounting hole including a plurality of insides and yield recesses which are located alternatively between the insides, a rail defined in an outer periphery of the socket and sharing an axis of the socket;
a control member rotatably mounted to the socket and having a through hole defined centrally therethrough and a plurality of stops extending inward from an inner periphery of the through hole, the stops being mad by resilient material, a ridge extending inward from an inner periphery thereof, the ridge movably engaged with the rail, the control member including an operation section and a function section, the function section being a ring-shaped portion so as to mount to the socket, the operation section connected axially to the function section, and
a polygonal object having sides and corners connected between the sides, a distance “B1” from an axis of the object to each one of the sides being not larger than a distance “A1” from an axis of the control member to each one of the stops of the control member, the distance “A1” being not larger than a distance “B2” from the axis of the object to each of the corners of the object and a distance “C2” from the axis of the socket to each of the yield recesses of the socket, a distance “B2” being not larger than a distance “A2” from the axis of the control member to the inner periphery of the through hole.

2. The assembly as claimed in claim 1, wherein the socket includes a positioning device and the control member includes a plurality of notches defined in an inner periphery of the through hole, the positioning device is removably engaged with one of the notches.

3. The assembly as claimed in claim 2, wherein the positioning device is a reception hole defined radially through a wall of the socket and a positioning unit is engaged with the reception hole, the positioning unit includes a bead and a spring which biases the bead to partially protrude from the outer periphery of the socket, the bead engaged with one of the notches.

4. (canceled)

5. The assembly as claimed in claim 1, wherein the control member is rotatable about the axis of the socket.

6. The assembly as claimed in claim 1, wherein the shape of the through hole of the control member is the same as the shape of the mounting hole of the socket.

7. The assembly as claimed in claim 1, wherein the engaging hole is in communication with the mounting hole.
